(19) United States
(12) Patent Application Publication
(10) Pub. No.: US 2003/0028831 A1
(43) Pub. Date: Feb. 6, 2003

(54) Centralised data position information storage system

(76) Inventors: Richard Arthur Bickers, Bristol (GB); Simon Rae, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 09/917,782

(22) Filed: Jul. 31, 2001

(51) Int. Cl. G06F 7/00

(52) U.S. Cl. 714/100

(57) ABSTRACT

A method of centralised data position information and storage and utilisation comprising the steps of arranging a byte stream of data into partitioned logical data, storing data position information relating to the logical data in a reserve storage area, transferring the information from the reserve storage area to a centralised storage area configured to store information relating to substantially all the partitioned logical data and utilising the information to locate a target data using a search algorithm.

### FIELD OF THE INVENTION

The present invention relates to a method an, apparatus of storing data position information relating to data distributed on a tape data storage device.

### BACKGROUND OF THE INVENTION

In order to store information it is known to use a magnetic tape storage system in which a magnetic tape is wound on reels or spools. These magnetic tape information storage systems are extensively used to back up archive and store data for future use by a user of, for example, a host user interface or PC.

A typical magnetic tape storage device 100 is illustrated in FIG. 1. The tape storage device 100 may be a stand alone unit, or may be integrated within a casing of a host computer entity 101. The data storage device is operable to receive data from a host computer entity and store data on a magnetic tape data storage medium, contained within a tape cartridge, and also to read data from cartridges, and input read data to the host computer 101.

Referring to FIG. 2 herein, there is shown schematically in external view, a typical known tape data storage cartridge 200, comprising a casing 201 containing in this case, a single reel upon which is wound a length of magnetic tape data storage medium. The magnetic tape data storage medium is wound in and out of the cartridge through an aperture 202, onto a reel within the tape data storage device in use.

Referring to FIG. 3 herein, there is illustrated schematically a cartridge 200 inserted into a tape data storage device 100, wherein a length of tape data storage medium 300 is wound from an internal reel 301 of the cartridge, through series of capstans and rollers 302-305 onto a second reel 306 comprising the tape data storage device. The tape data storage device comprises a read/write head 307 over which the tape is drawn, in forward and reverse directions, to apply read or write operations of user data to the tape.

Typically, the tape drive controls the movement of the tape over the write head to record data onto the magnetic tape, and over the read head to generate an electrical signal from which the stored data can be reconstructed. Commonly, the read and write heads may be combined into a single read/write head, this head being controlled by the tape drive.

A length of magnetic tape as known in the art is illustrated in FIG. 4 such that data is recorded onto the tape in a series of data tracks 400. When an command is issued by a host computer to read a specific target data on the tape the tape drive using a read head must scan the data tracks 400 to locate the position of the target data thereby allowing the read head to retrieve the data and transfer it back to the host. The tape drive, being configured to ascertain a current position on the tape relative to the Beginning Of Tape or Wrap (BOW), scans the data tracks 400 until the read head passes over a directory 401 positioned at the BOW. In the example shown here, the directory being located at the BOW is configured such that its contents are distributed across the tapes, at the end of each Wrap as shown in FIG. 4. The contents of the directory 401 coincide to the separate data tracks 400, such that the contents of the directory 401 located at the BOW or the EOW are used to allow the tape drive to determine if the target data is contained on a relevant data track. If data position information in the area 401 indicates that the target data is not located in a particular data track then the drive must continue reading the data until it comes across the target data. Similar prior art data storage systems utilise a directory stored in a cartridge memory rather than on the tape, data being accessed on tape by a read operation of the cartridge memory.

When recording data onto a magnetic tape it is known to partition the data into a plurality of data sets, such data sets being distributed across the various data tracks. The partitioning of data into data sets distributed across the data tracks provides a physical position of any one particular data set relative to, for example the BOW and EOW. Such a physical positioning being provided as the data sets are spatially separated along the length of the tape.

Within one particular data set the data is further partitioned into a series of records and filemarks, such partitioning giving rise to a logical data position for any particular record or filemark.

Magnetic tape data storage systems known in the art having directories 401 associated with a corresponding data track 400 along the length of a tape, utilize such directories to store logical data position information as detailed in FIG. 5. A data track 400 is illustrated as having data 500 distributed across its length. The data 500 within a data set and positioned on a data track 400 has corresponding data position information stored within the directory as record data position information 501 and filemark data position information 502. Commonly, the directories also contain data position information 303 relating to the positioning of data sets distributed across the length of the data track 200.

Referring to FIG. 6 there is detailed a typical mode of operation of a prior art magnetic tape data storage system having received a target data command from a host. Using the directory located at the BOW, and in particular the contents of the directory located at the BOW and EOW corresponding to a particular data track, the tape drive determines a required tape motion so as to position the read head on a data track corresponding to the data track on which the target data is positioned. The directory contents information at the BOW and the EOW providing information on the positioning of the target data within this particular data track. As the read head is effectively transported to a new data track as shown in FIG. 6 the tape motion may be such that the read head is being transported away from the target data position B. The read head must serially read the data track until it is determined, using the contents of the directory information at the EOW (as shown in FIG. 6) that the tape motion should be reversed in order to allow access to the target data B. Essentially, each data track information area 401 functions as a map of the logical position of the data to the actual physical position of the data on the tape, this data being partitioned into data sets distributed along data tracks. Obviously, the more information a directory, located at the BOW contains, the more complete the mapping of the physical position of data on tape.

However, a prior art storage device having a complete directory (containing information relating to all data on tape) is restricted by the read speed of the tape drive due to the serial reading operation as detailed in FIG. 6 when the read head traverses from, for example, A to target data B. Moreover, a directional change of tape motion is undoubtedly required at some stage of the data retrieval process, this adding to the data access time.

Accordingly, the inventors have identified various problems associated with the employment and utilisation of such magnetic tape data storage systems as described above and known in the art. The problems identified by the inventors include:

Utilising data position information in a distributed manner (the spatially separated directories 401) results in excess tape motion and in particular multidirectional changes. This excessive tape motion inevitably leads to a longer time period taken from the issuing of a target data request and the actual reading and retrieval of the target data.

Due to the operational nature of the magnetic tape system, target data searching within a particular data track 400 is undertaken at read speeds, these speeds being dictated by the read head and the processing power of the tape drive, such a constraint serving to increase the above identified searching time period. An additional problem associated with the necessity to engage the read/write head is the excessive reading of data and data position information on data tracks in an attempt to locate the target data, as detailed in FIG. 6. The magnetic tape, although generally long lasting, is subject to deterioration in the event of excessive tape motion and engagement by read/write heads. Excessive reading operations also reduce the lifetime of the read head.

The inventors have recognised a need for a magnetic tape data storage system having a centralised data position information storage utility capable of stoning data position information relating to data distributed across the tape. Such a system being capable of providing a data position information storage area that can be loaded and unloaded separately to the data stored on tape. The method and apparatus of such a system having an accelerated target data searching utility in relation to that found in the art, is disclosed in detail herein below.

### SUMMARY OF THE INVENTION

The inventors, on recognising the various problems associated with prior art data storage systems, provide a magnetic tape data storage system having a centralised data position information storage area being effectively a pseudo map of the data distributed across the length of tape. By utilising data position information stored centrally, and not distributed across the length of tape as found in the art, the inventors provide a robust data storage system capable of enhanced data access times following the receipt of a target data request from a host.

According to one implementation of the present invention, following receipt of a target data request from a host, the centralised data position information storage area is accessed and the exact position of the target data, on the magnetic tape, determined thereby necessitating a single tape displacement action to access this target data. This single tape displacement being in contrast to the operational nature of prior art storage systems.

Utilising a centralised storage area provides a data storage system capable of loading and unloading data position information, at for example, the beginning and end of a data access session, respectively. According to further aspects of the present invention the centralised storage area is configurable for updating during data access operations such that at the end of a user session the updated centralised storage area may be downloaded to a suitable reserve storage area where it remains dormant until it is required by the storage device upon which time it is reloaded into the centralised storage area for use in determining a target data position on the tape.

In another implementation of the present invention the centralised data position information storage area is configurable to store data position information relating to selected groups of data distributed across the length of tape. This type of formatting provides a centralised storage area containing data position information relating to striped bands of data along the total length of the tape. This reduces the required capacity of the centralised storage area due to the reduced resolution of the pseudo data map.

According to a first aspect of the present invention there is provided a method of centralised data position information storage and uitilisation comprising the steps of:

arranging a byte stream of data into partitioned logical data;

storing data position information relating to said logical data in a reserve storage area;

transferring said information from said reserve storage area to a centralised storage area, wherein said centralised storage area is configured to store said information relating to substantially all said partitioned logical data; and

utilising said information in said centralised storage area to locate a target data being part of said logical data.

According to a second aspect of the present invention there is provided a method of storing and utilising data position information on a tape data storage device, said method comprising the steps of:

arranging a byte stream of data into partitioned logical data and recording said logical data onto a length of tape;

storing data position information relating to said logical data in a reserve storage area,

transferring said information from said reserve storage area to a centralised storage area located within said tape device, wherein said centralised storage area is configured to store said information relating to substantially all said partitioned logical data; and

utilising said information in said centralised storage area to locate a target data on said tape, said target data being part of said logical data; and

reading said target data using a read head.

According to a third aspect of the present invention there is provided a data position information storage and utilisation device comprising:

partitioned logical data distributed across a length of tape;

a reserved storage area to store data position information relating to said logical data;

a centralised storage area configured to store said information received from said reserve storage area, said centralised storage area being configured to store information relating to substantially all said partitioned logical data; and

a search algorithm to locate a target data on said tape; and

a read head configured to read said logical data on said tape;

wherein said device is operable, in response to a request for said target data, to locate said target data on said tape using said information in said centralised storage area and to read said target data using said read head.

According to a fourth aspect of the present invention there is provided a computer program comprising program commands for implementing a method of centralised data position information storage and utilisation, said method comprising the steps of:

arranging a byte stream of data into partitioned logical data,

storing data position information relating to said logical data in a reserve storage area;

transferring said information from said reserve storage area to a centralised storage area, wherein said centralised storage area is configured to store said information relating to substantially all said partitioned logical data; and

utilising said information in said centralised storage area to locate a target data being part of said logical data.

According to a fifth aspect of the present invention there is provided a computer program comprising program commands for implementing a method of storing and utilising data position information on a tape data storage device, said method comprising the steps of:

arranging a byte stream of data into partitioned logical data and recording said logical data onto a length of tape;

storing data position information relating to said logical data in a reserve storage area;

transferring said information from said reserve storage area to a centralised storage area located within said tape device, wherein said centralised storage area is configured to store said information relating to substantially all said partitioned logical data; and

utilising said information in said centralised storage area to locate a target data on said tape, said target data being part of said logical data, and

reading said target data using a read head.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates a tape data storage device being connected to a host;

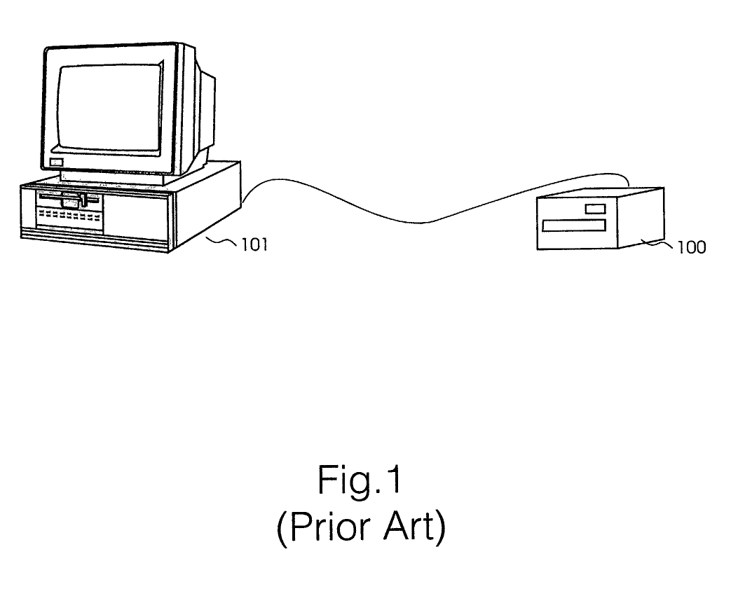

FIG. 2 illustrates schematically a tape data storage cartridge of a single reel type containing an elongate magnetic tape data storage medium;

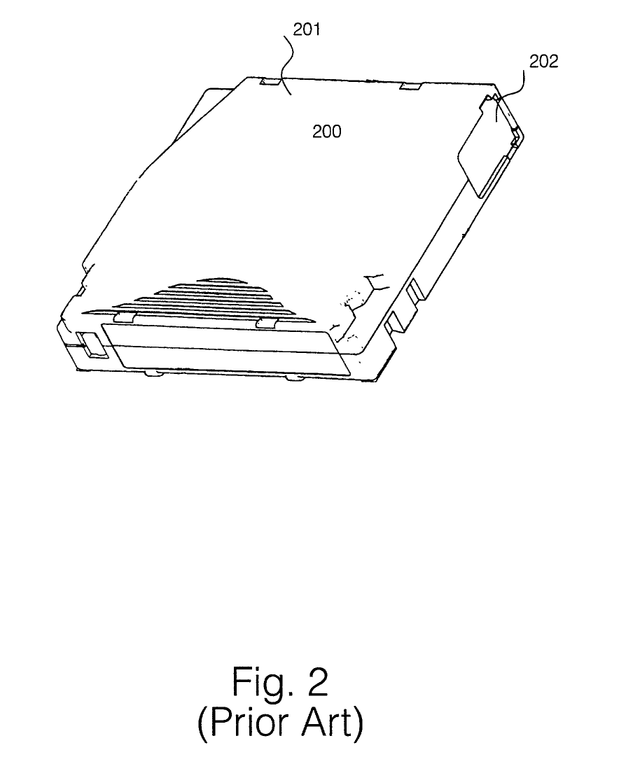

FIG. 3 illustrates schematically operation of a tape data storage device for reading and writing data to a tape data storage medium inserted into the device, as is known in the prior art;

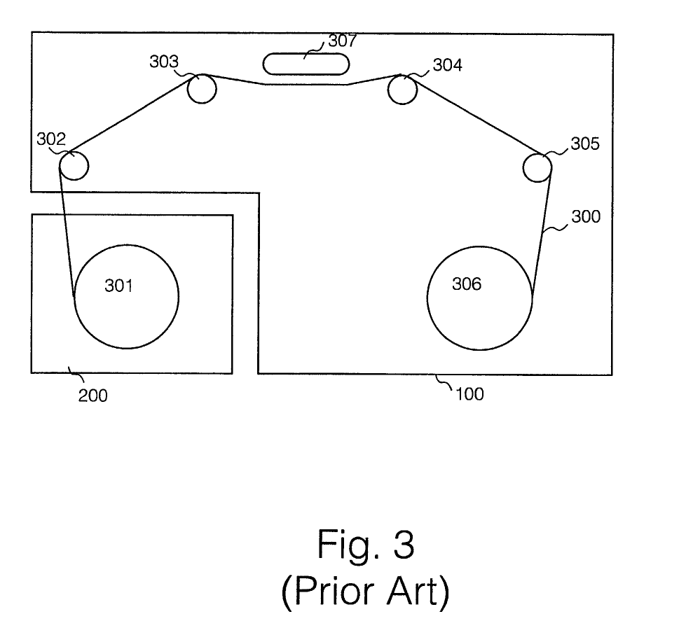

FIG. 4 illustrates a length of prior art magnetic tape configured to store logical data and logical data position information;

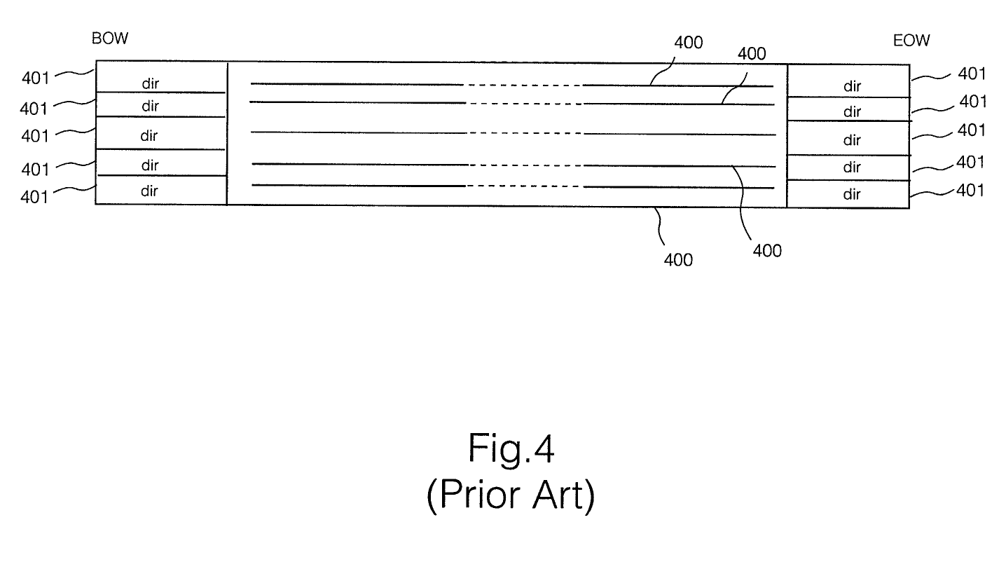

FIG. 5 illustrates the arrangement of data position information storage within a prior art data storage device;

FIG. 6 illustrates an operational mode of a prior art data storage device being operable to access data following a data request from a host;

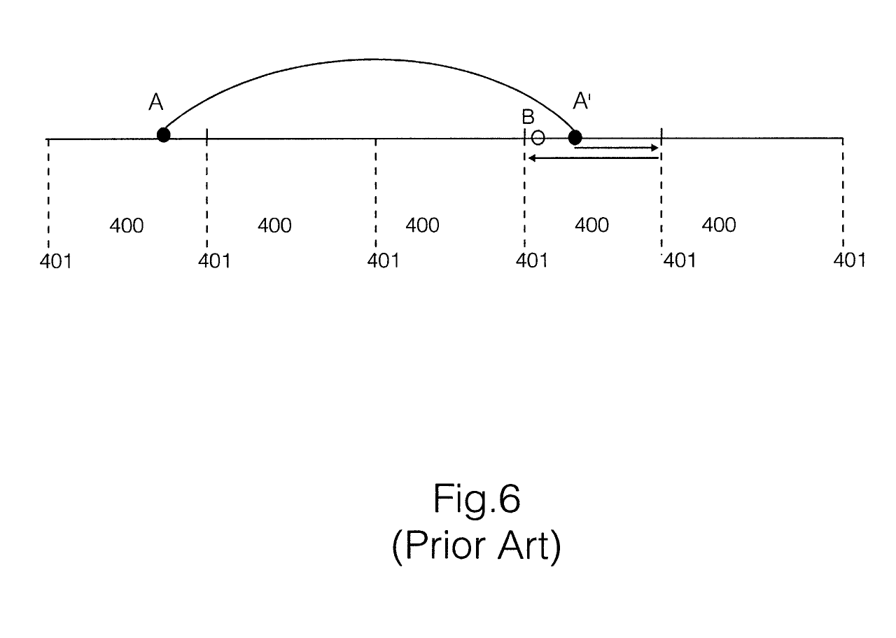

FIG. 7 illustrates a logical pipeline, a logical media having a centralised storage area and a physical pipeline according to a specific implementation of the present invention;

FIG. 8 illustrates a portion of the centralised data position information storage area being a data table.

FIG. 9 illustrates a flow diagram detailing the general operational nature of the data storage system.

FIG. 10 illustrates the relationship between a start position and a data target in terms of a logical displacement and a physical displacement on a tape;

FIG. 11 illustrates a length of magnetic tape being partitioned into selected data groups;

FIG. 12a illustrates the initial stages of a flow diagram describing the operational mode of the storage device according to a specific implementation;

FIG. 12b illustrates a continuation of FIG. 12a detailing the operational mode of the storage device according to a specific implementation;

FIG. 12c is a further continuation of FIG. 12a detailing the operational mode of the storage device according to a specific implementation;

FIG. 13a illustrates a flow diagram detailing the initial stages of the search algorithm configured to locate a data target according to a specific implementation of the present invention;

FIG. 13b illustrates a continuation of the flow diagram as detailed in FIG. 13a;

FIG. 13c is a further continuation of the flow diagram as detailed in FIG. 13a;

FIG. 13d is a further continuation of the flow diagram as detailed in FIG. 13a.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

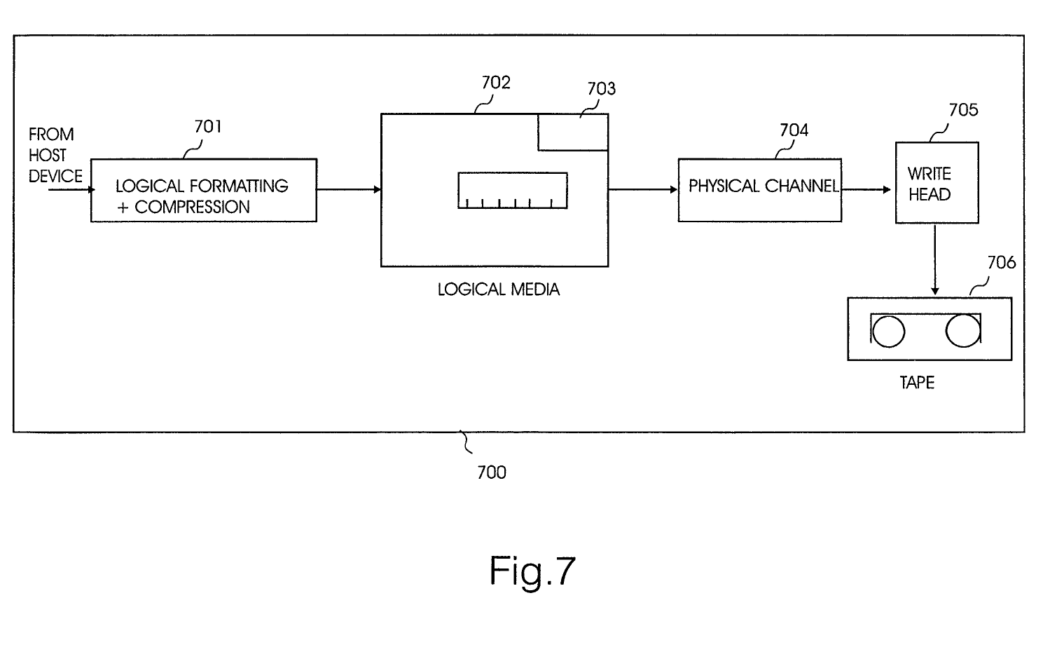

Referring to FIG. 7 there is illustrated three components of a data formatting channel 700 according to a specific implementation of the present invention, The channel 700 comprises a logical data pipeline 701 being operative to perform logical formatting of user data and to compress user data; a host a logical media 702; and a physical pipeline 704. The user data on passing through the logical pipeline, is partitioned into data set form, the compressed data is then transferred to logical media 702 configured with an updateable centralised data position information storage area 703; storage area 703 when constructed, being effectively a pseudo data position map of logical data stored on a length of magnetic tape. The logical media 702 holds a logical representation of the data stored on tape, in the storage area 703 in the form of an index data.

The channel is then divided into a physical pipeline 703, being operative to format the logical data into a physical format such that the data can be written to a length of magnetic tape in a predetermined format.

The components 701, 702 and 704 may be implemented in the best mode as firmware, e.g. an application specific integrated circuit, or as code.

According to the specific implementation of the present invention the logical media 702 is a dynamic random access memory (DRAM), such a storage area memory being volatile, in that information stored within the storage area may not be retained in the event of a termination of power to the logical media.

The logical data received from a host is formatted in the logical pipeline 701 to provide partitioned logical data, this partitioning being in terms of individual records and filemarks. The formatted logical data being in a data set form is then passed through the logical media and into the physical pipeline 704. The physical pipeline is configured to add error recovery information to each data set before being written onto tape. The data sets are written onto the tape according to the next available piece of tape for storing data. The data sets, according to the specific implementation of the present invention, are not necessarily always the same physical size, and accordingly a different number of data sets may be written on different physical data tracks.

According to the specific implementation of the present invention data position information is loaded into the centralised data position information storage area 703 from a reserve storage area, for example, a cartridge memory device, at some stage prior to the receipt of a target data request issued by a host. In further specific implementations of the present invention the centralised data position storage area 703 accumulates data position information as the data is processed according to 701 and 704. Once data position information is stored in the storage area 703 it can, at some future stage be transferred or downloaded to a suitable reserve storage area for future use.

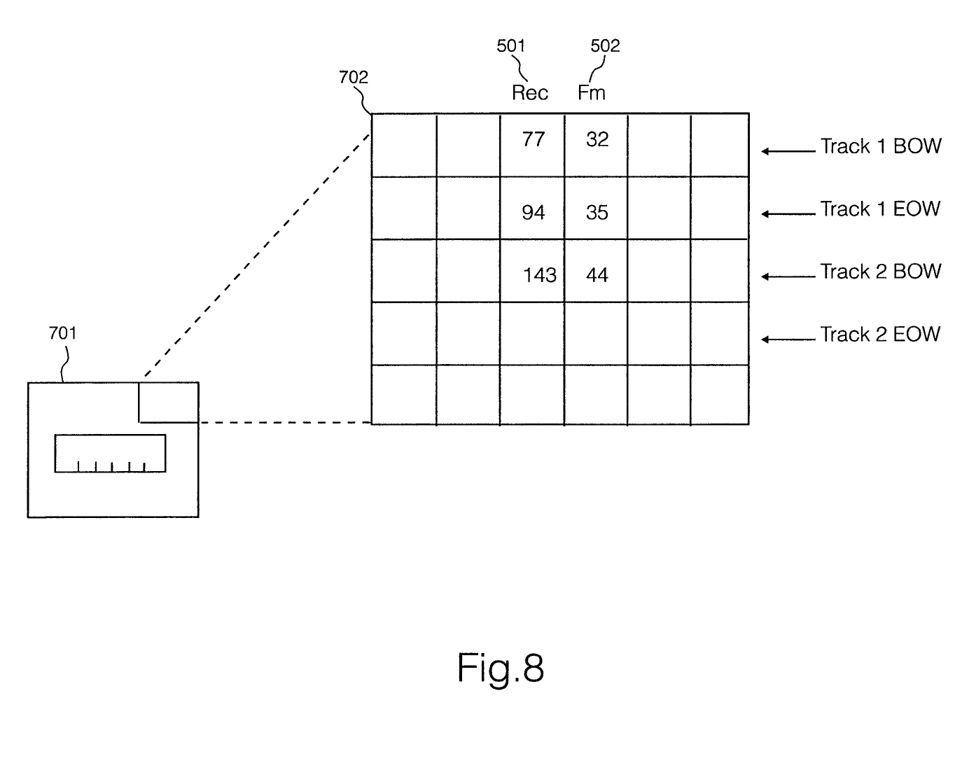

Referring to FIG. 8 there is illustrated a portion of the centralised data position information storage area 703 forming part of the logical media 702. The storage area 703 comprises a data table being configured to store logical data position information relating to logical record data and logical file mark data. The logical data position information located within the data table 703 is arranged such that a logical data position has a corresponding physical position on the magnetic tape, such a physical position being in terms of a physical track number and a physical data set number, such parameters being relative to the BOW or EOW. The logical data position information contained within the data table 703 may, according to the specific implementation of the present invention relate to all data distributed against the length of tape. In a further specific implementation of the present invention the logical data position information within the data table 703 corresponds to selected data groups, such data groups being spatially distributed across the length of magnetic tape. The benefit of storing data position information relating to selected data is that the storage area 703 requires less capacity within the logical media 702 for data position information storage.

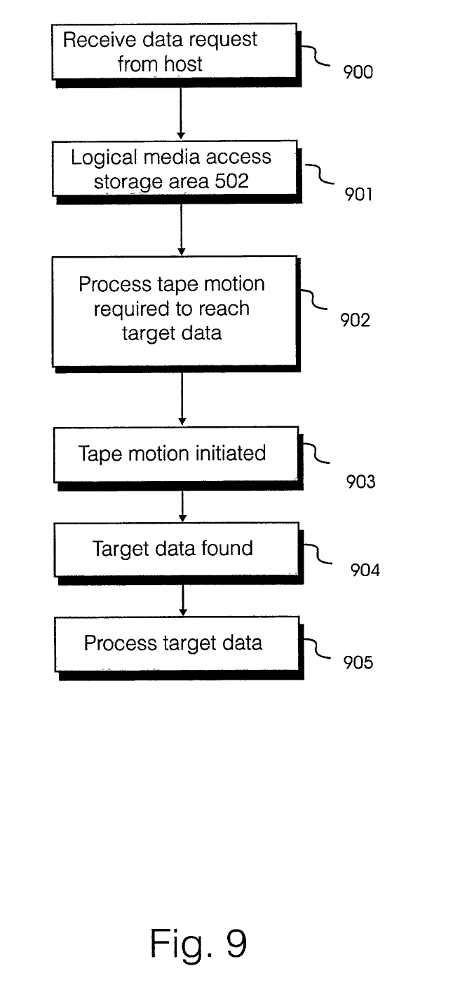

FIG. 9 illustrates a flow diagram detailing the general mode of operation of the specific implementation of the present invention. Following the initial writing of data received from a host onto the length of magnetic tape, and the loading into the centralised data position information storage area with data position information, a target data request is received from a host at stage 900. Such a target data request being issued, for example, by a user requiring specific data for use, for example, in an application. The data request 900 requires the tape drive, and in particular a read head forming part of the drive, to access the target data and transfer or output this data to the host. The logical data position and the physical data position of this target data is determined by the logical media via the centralised data position information storage area at stage 901. The logical media, having a searching utility in the form of a searching algorithm determines the tape motion required to allow the read head forming part of the tape drive, to access the target data at stage 902. The tape motion determined by the logical media 702 is based on the current tape drive position, defined by logical positional parameters (records and file marks), logical data position information within the storage area 703, and an estimation made by the search algorithm, of the position of the target data. The logical media calculates the required tape motion to, for example, change data tracks and data sets to access a record or plurality of records (being the target data). If the centratised data position information storage area contains information relating to substantially all the data recorded onto the magnetic tape the estimation of the target data position is an actual determination of the target position and as such the read head can be positioned over the target data requiring a single tape displacement motion. However, if according to further specific implementations of the present invention, logical data position information is stored in the storage area 703 relating to selected groups of data distributed across the length of tape, it is envisaged that the target data request relates to data not having its position stored in the storage area 703. In such a scenario the read head is required to perform localised iterative searching operations to locate this target data in close proximity to the estimated position undertaken at logical media stage 702. Such searching is undertaken as the data is transported passed the read head, due to, in this specific embodiment, the displacement of the magnetic tape.

At stage 903 the tape motion is initiated to allow the read head to access the target data or estimated target data on the magnetic tape. Once the target data is found at stage 904 the data is processed by the logical media at stage 905.

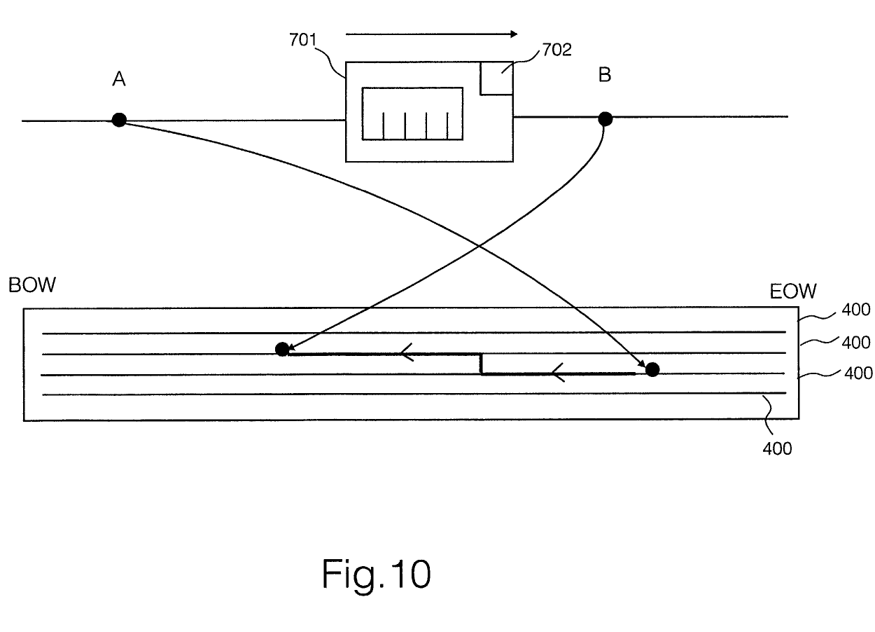

Referring to FIG. 10 there is illustrated a logical data position of target data B relative to a starting logical data position A together with the actual physical data positions of B and A on a length of magnetic tape. The logical media 702 is illustrated in FIG. 8, having just received a target data request from a host and as such, following the estimation of the target data position (B), moves from starting logical data position A to this new position B.

In terms of the physical data position of B relative to A on the magnetic tape, and as illustrated in FIG. 8 the logical media, and in particular, the read head must traverse back from position A along a data track 400, swap data tracks and continue traversing back towards the beginning of Wrap or tape (BOW) arriving ultimately at position B. The logical media 702, according to the specific implementation of the present invention determines the physical data position of the target data with reference to a data set number and track number and also determines the logical data position with reference to a record number and a filemark number. The traversing of the logical media from physical position A to physical position B, as illustrated in FIG. 8, is possible due to the data position information contained in the updateable centralised data position information storage area 703—this area containing useful data position information to determine the target data position B.

The physical data position of target B is determined by the logical media accessing logical data stored in the storage area 703. The physical position of a target data is determined by the arrangement of logical data within the data table of the storage area 703, the data table being arranged according to a specific embodiment of the present invention in columns of record numbers and file marks, such records and file marks being related to a physical data set on a physical data track by the inclusion within a particular row of the data table.

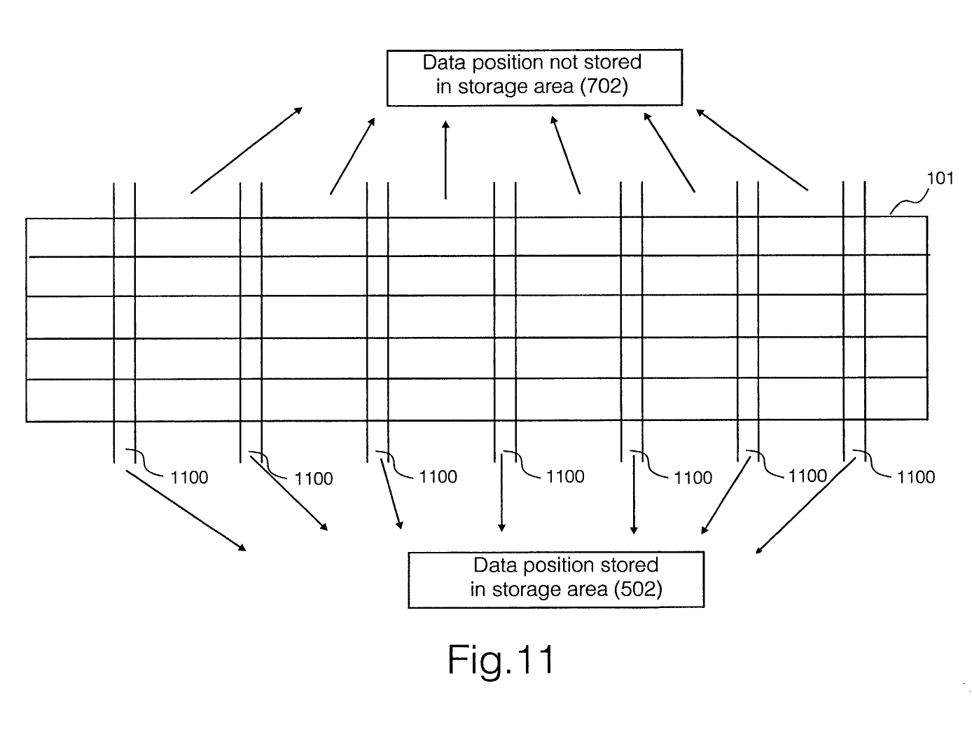

Referring to FIG. 11 there is illustrated the storing of selected logical data position information relating to selected and partitioned logical data distributed along the length of magnetic tape, according to a further specific implementation of the present invention. The centralised data position information storage area 703, according to a further specific implementation, is configured to store data position information relating to a percentage of the total partitioned logical data distributed across the length of tape. The centralised storage area 703 having an incomplete pseudo map of the logical data on tape, requires reduced capacity for such information storage and accordingly the capacity of the logical media may be utilised for additional applications. FIG. 11 illustrates a centralised storage area 703 having data position information stored in its data table relating to logical data distributed across the length of tape in selected data groups 1100, such data groups being effectively, according to the further specific implementation of the present invention, stripes of data as illustrated in FIG. 11. Logical data position information relating to data not within the selected data group 1100 is not stored in the storage area 703.

The logical media 702, when requested to access a target data not falling within a selected data group 1100, whose data position information is not stored within the storage area 703, must perform an effective local search, to access such data using the data position information of data within a nearest selected data group 1100. In such a scenario the logical media 702 determines a data position of data having data position information stored in the storage area 702, such information relating to data within a selected data group 1100. The read head is then positioned over such data (within a selected data group) the logical media then scans the tape, in a first tape motion direction, to locate the target data. It will be appreciated, by those in the art that the furthest physical displacement of the tape during any particular localised search, is the displacement from one selected data group to a next nearest neighbor selected data group 1100. According to yet further specific implementations of the present invention the distance between selected data groups 1100, along the length of tape, may be small so as to reduce the time taken for localised data searching. Conversely, and to minimise the amount of information stored within the storage area 703, data position information stored within the storage area 703 may relate to relatively narrow selected data groups 1100 distributed along the length of tape whereby the data groups 1100 are separated from each other by relatively large distances, such formatting requiring a possible increased time period for a target data to be located during a local search.

According to the specific implementation of the present invention the storage area 703 is configured with logical data position information related to substantially all the partitioned (in terms of data sets) logical data distributed across the length of tape, such partitioned logical data not being divided into selected data groups 1100 as illustrated in FIG. 11. The logical media 702 having the effective pseudo map of the partitioned logical data distributed along the length of tape can identify the logical and physical position of a target data, without the need to resort to localised searching being conducted between neighboring selected data groups 1100 as identified above.

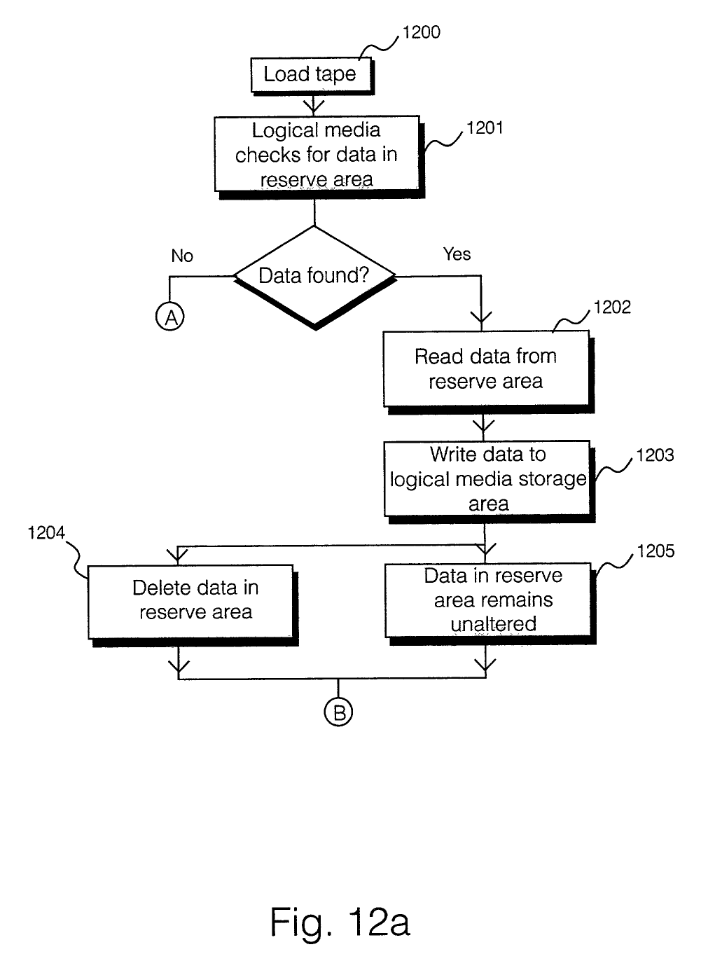

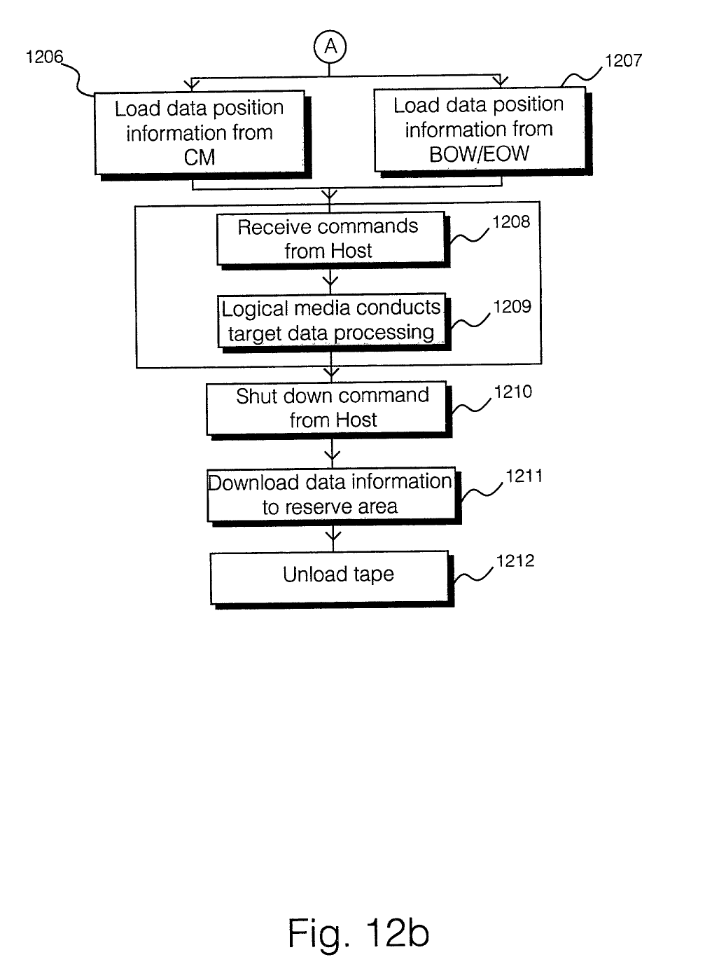

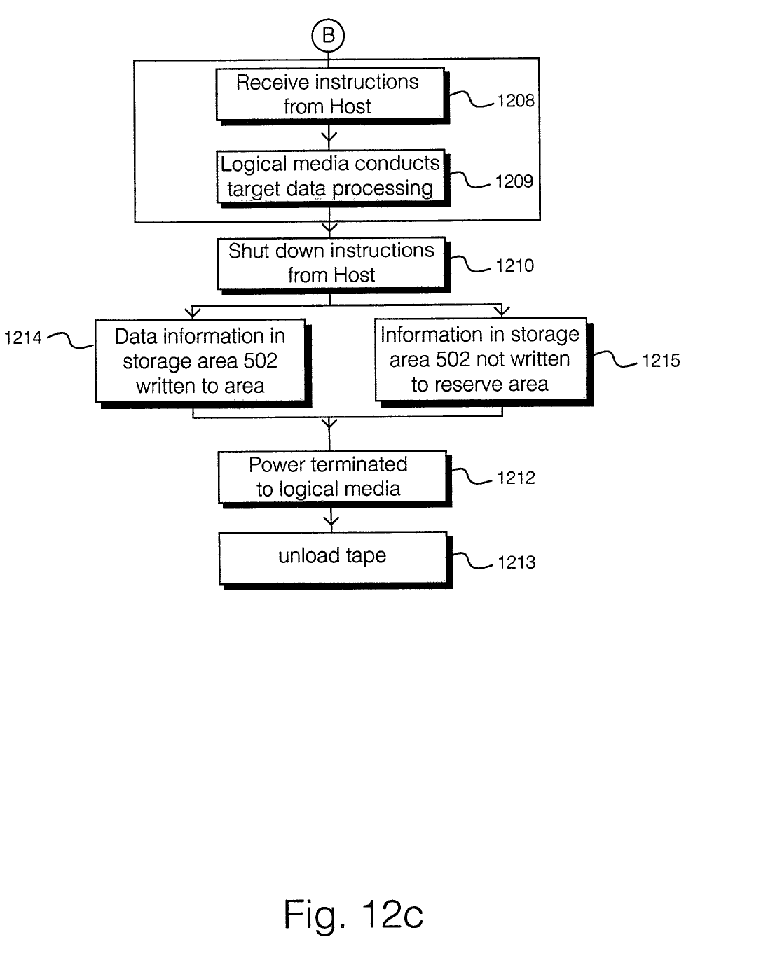

Referring to FIG. 12a there is illustrated a flow diagram detailing the initial stages of an initialisation procedure following which the centralised data position information storage area 703 contains data position information relating to logical data distributed across the length of tape. A length of tape is loaded onto a spool or reel within the storage system at stage 1200. The logical media 702 then performs a check procedure to determine if data position information is stored within a reserve storage area at stage 1201. Such a reserve storage area being a suitable cartridge memory(CM) connected to or forming part of the storage system, a suitable storage area located on the tape or a further storage area positioned within the storage system or being a separate entity connected by suitable connecting means. If data position information is found within the storage area the data position information is read by the logical media at stage 1202 and subsequently written to the storage area 703 at stage 1203. Following the loading of data position information into the storage area 703 at stages 1202 and 1203 the data table forming the storage area 703 contains information relating to logical data distributed along the length of tape, the data table being an effective pseudo map of the logical data magnetic tape. The logical media is configured to possibly delete data within the reserve storage area 1204, such data deletion being a preparatory stage in the event of a subsequent information download from the storage area 703 to the reserve storage area. Conversely, the data position information within the reserve storage area may be preserved at stage 1205, such data position information thereby being available for future utilisation by the logical media through stages 1202 and 1203.

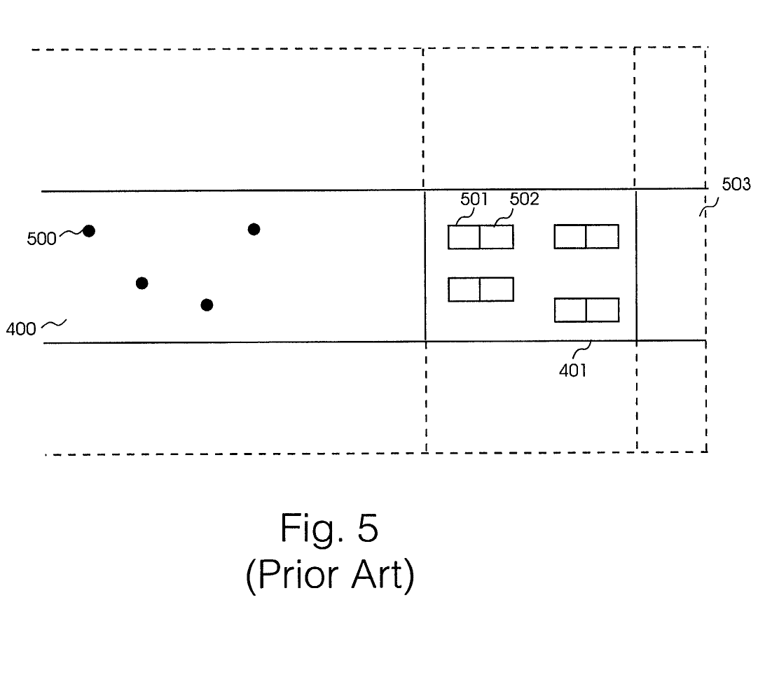

Following stage 1201 in which the logical media checks for data within the reserve storage area, if it is found that no data exists in this area data position information relating to data distributed along the length of tape, must be loaded into storage area 703 from a separate location. Such a procedure is detailed with reference to FIG. 12b. In the event of an initial blank reserve storage area data position information may be loaded from a suitable CM at stage 1206. The logical media is also configured to received data position information loaded from the directories 401 located on tape at, for example, the BOW or EOW, at stage 1207. Such directories containing data position information relating to the logical data distributed along the length of tape as illustrated with reference to FIG. 5.

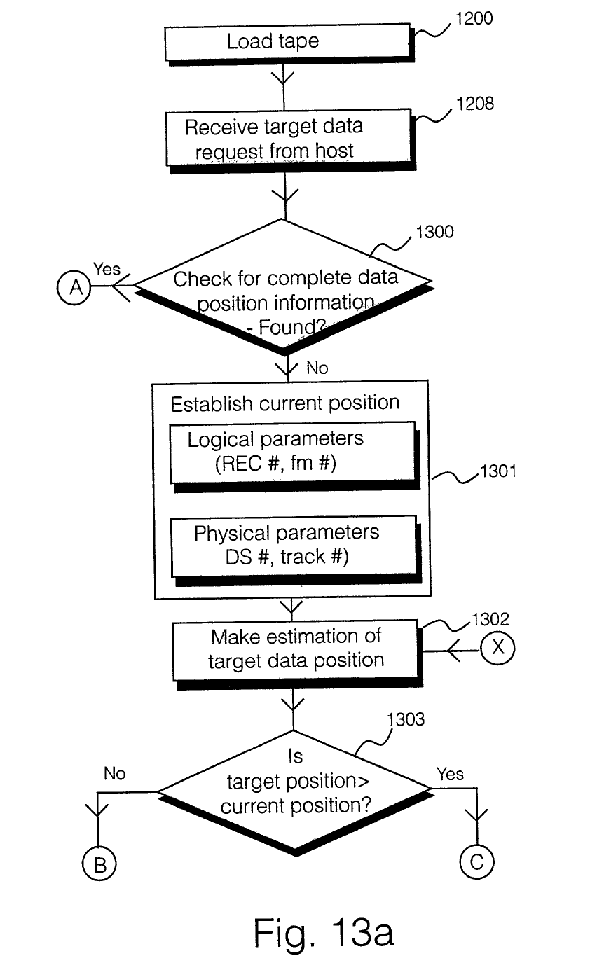

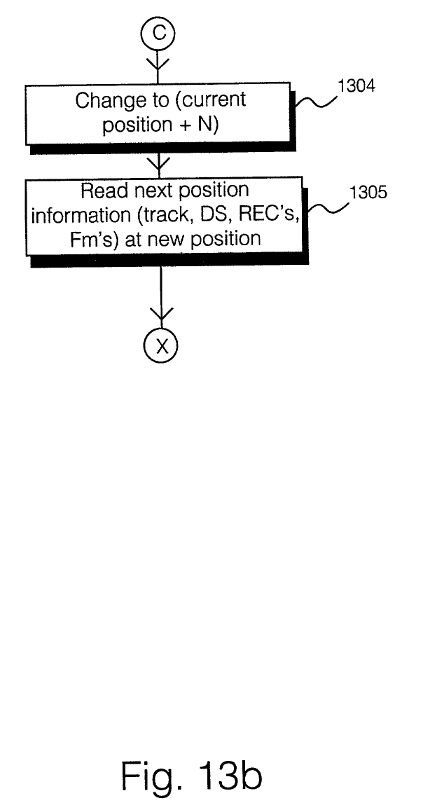

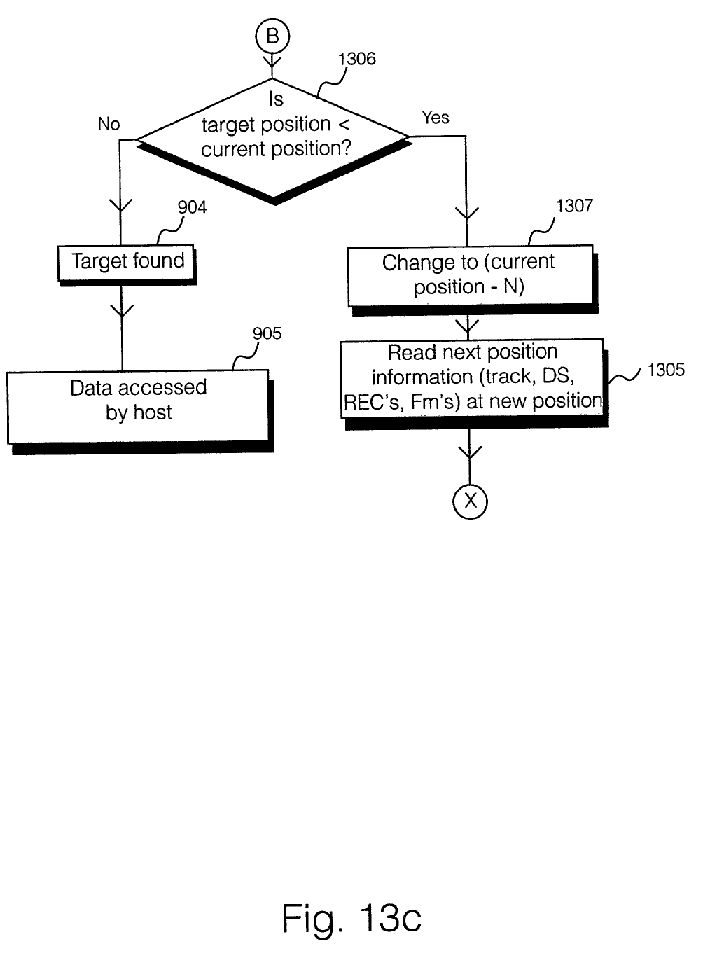

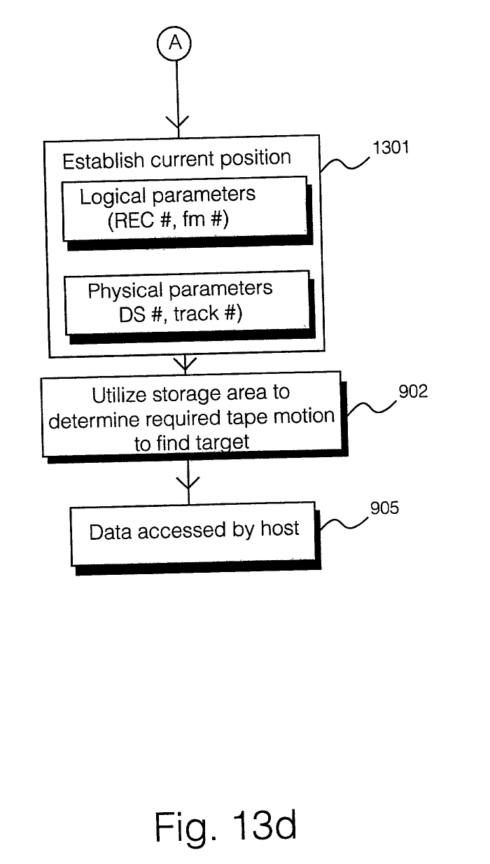

Following the loading of data position information into storage area 703 forming part of the logical media 702, the storage system is configured to receive an command from a host to locate and provide access to a target data at stage 1208. Using a suitable search algorithm as detailed with reference to FIGS. 13a-d, the logical media utilises the data position information within the storage area 703 to process target data requests at stage 1209 whereby target data is transferred from the storage system to a host. When in operation the storage system is configured to perform multiple target data requests utilising data position information within the logical media. A shut down command is then issued by the host at stage 1210, data position information is then downloaded to the reserve storage area at stage 1211. Data position information within this reserve storage area may then be used for subsequent initialisations of the logical media as detailed with reference to FIG. 12a. According to the specific implementation of the present invention the logical media is a dynamic random access memory DRAM, such that as the tape is unloaded from the storage system at stage 1212, the logical media does not retain information relating to a previously loaded tape.

With reference to FIG. 12a, FIG. 12c details the further procedure following the loading of data position information from the reserve storage area to the storage area 703 within the logical media, The storage system having a logical media configured with a data table comprising data position information relating to logical data distributed along the length of tape, is now configured to receive a target data command from a host at stage 1208 following the receipt of such a target data command the logical media, as detailed above, conducts target data processing at stage 1209. Following the undertaking of a single or multiple target accessing operations a shut down command is issued from the host at stage 1210, such a shut down command being followed by the loss of power to the logical media. In the event of the logical media, and in particular, the storage area 703 being a volatile memory (DRAM), data position information may be downloaded from this storage area to a suitable reserve storage area in order to preserve data position information. Accordingly, data position information within the storage area 703 is written to the reserve storage area at stage 1213. The transferring of data position information at stage 1213 would be appropriate if, according to further specific implementations of the present invention, the logical media is configured to update the storage area with data position information relating to data having been updated on the length of tape. According to this further specific implementation of the present invention, the logical media is configured to update the storage area 703 with data position information during a target data access operation following the receipt of a target data command issued by a host. In the event of a centralised storage area 703 having incomplete data position information relating to logical data stored on tape, the logical media is configured to dynamically build the storage area with data position information each time the tape is displaced and a data read operation undertaken. The updating of the storage area 703 being possible though the utilisation of a suitable update algorithm or algorithms being operative to determine a logical data position and physical data position with reference to a known position and to store this new data position information within the centralised storage area 703.

According to an alternative procedure of the specific implementation, data position information within storage area 703, following the command to shut down from the host at stage 1210 is not written to the reserve storage area at stage 1214. The step of not writing data to the reserve storage area may, for example, may be required in the event of data being corrupted within the centralised storage area 703 In such an event, the corrupted data within the storage area 703 following the unloading of the tape at stage 1212 would be lost such that the storage area 703 could then be loaded with uncorrupted data position information from a suitable reserve storage area.

Referring to FIG. 13a there is illustrated a flow diagram detailing the initial stages of a data retrieval by the logical media from a magnetic tape data storage medium. Initially, the tape is loaded into the storage system at stage 1200. A target data request is then received from a host at stage 1208. The logical media 702 then checks the centralised data position information storage area 703 for complete data position information relating to substantially all the partitioned logical data distributed along the length of tape at stage 1300.

If the centralised data position information storage area 703 contains data position information relating to, for example, selected data groups distributed along the length of tape (an incomplete storage area) the logical media must perform at least one localised search in order to determine the target data position based on data position information which relates to data being positioned in close proximity to the target data on the magnetic tape. In the event of an incomplete centralised storage area 703, according to the further specific implementation of the present invention, the logical media 702 establishes the current position at stage 1301, the current position being in terms of logical data position parameters (record numbers and file mark numbers) and physical data position parameters (data set numbers and track numbers). The determination of the current position being conducted by the engagement of the read head forming part of the tape drive. The logical media then makes an estimation of the target data position at stage 1302 based on the current position parameters and any useful data position information within the storage area 703, such useful data position information being in particular, information relating to data located in close proximity to the target data position on the magnetic tape. The estimated target data position is then compared with the current position at stage 1303 if the estimated target data position is greater than the current position the logical media, via the tape drive changes its current position within a particular data set and on a particular data track to a current position +N as detailed in FIG. 13b. Where N is an integer and dependent upon the physical layout of data tracks on the magnetic tape. For example, the formatting of data tracks on the tape according to the present invention, may take the form of a series of parallel tracks running the length of the tape or alternatively a squashed square spiral in which data is first written onto the centre of the tape such that subsequently written data extends out from this central position in a square spiral. For example, the estimated target data position may be a factor of 10 greater than the current data position on the tape, and as such the tape drive via the logical media, displaces the tape (in terms of data sets and data tracks, by the appropriate parameter N). Following the change of position as detailed at stage 1304 the new data position of the logical media 702 on the tape is read at stage 1305, this new position being in terms of physical track and data set number and logical record and file mark number. Stages 1302 and 1303 are then repeated in order to determine if the new data position is the desired target data position. With reference to FIG. 13c if the estimated target data position is found to be not greater than the current position the logical media determines if the estimated target data position is less than the current position at stage 1306. If the estimated target data position is found to be less than the current position the logical media determines that the tape drive should change position from its current logical and physical data position to this position −N, as detailed at stage 1307. Following such a change in position the new data position is then determined by the read head and logical media, in terms of track number, data set number, record number and file mark number, at stage 1305. A selected number of the above stages are then repeated in order to determine if the target data position has been located. If following stage 1306 it is determined that the estimated target data position is not less than the current data position then the logical media determines that the target data is found according to stage 904, such that at this position the read head can then access the target data at stage 905.

With reference to FIG. 13a, FIG. 13d details the subsequent procedure following the determination of a complete data position information storage area as detailed at stage 1300. According to the specific implementation of the present invention if the storage area 703 contains data position information relating to substantially all the partitioned logical data distributed along the length of tape, the logical media establishes the current position at stage 1301. The logical media then utilises the data position information within the storage area 703 to determine a required tape motion to locate the target data at stage 902 when the read head is located over the target data it can be read and transferred to the host at stage 905.

As will be appreciated by those skilled in the art, the specific and further implementations of the present invention are configured for operation when utilised in a storage system in which the tape drive is displaceable relative to the magnetic tape medium. Such a system, utilising a static tape with displaceable tape drive is operative to locate a target data, following a request from a host, due to the availability of data being able to be transported passed the read head of the tape drive.

The transporting of logical data passed the read head is common to both operational methods of the storage system described herein, in which the tape drive is static and the magnetic tape is displaceable, and a system in which the tape drive is displaceable and the magnetic tape is static,

1. A method of centralised data position information storage and uitilisation comprising the steps of:
arranging a byte stream of data into partitioned logical data;
storing data position information relating to said logical data in a reserve storage area;
transferring said information from said reserve storage area to a centralised storage area, wherein said centralised storage area is configured to store said information relating to substantially all said partitioned logical data; and
utilising said information in said centralised storage area to locate a target data being part of said logical data.

2. The method as claimed in claim 1, wherein said step of utilising said logical data position information comprises:
applying a search algorithm to said data position information;
wherein said search algorithm is configured to locate said target data.

3. The method as claimed in any one of claims 1 or 2, wherein said logical data comprises:
records and filemarks; wherein said centralised storage area is configured to store data position information relating to said records and said filemarks in a data table.

4. The method as claimed in claim 1, wherein said centralised storage area is configured to store logical data position information relating to a plurality of selected logical data groups.

5. A method of storing and utilising data position information on a tape data storage device, said method comprising the steps of:
arranging a byte stream of data into partitioned logical data and recording said logical data onto a length of tape;
storing data position information relating to said logical data in a reserve storage area;
transferring said information from said reserve storage area to a centralised storage area located within said tape device, wherein said centralised storage area is configured to store said information relating to substantially all said partitioned logical data; and
utilising said information in said centralised storage area to locate a target data on said tape, said target data being part of said logical data; and
reading said target data using a read head.

6. The method as claimed in claim 5 wherein the step of transferring said data position information comprises:
transferring said information to a data table within said centralised storage area;
wherein said information within said data table is arranged so as to minimise a time period taken to locate said target data on said tape when utilising said information.

7. The method as claimed in claim 5 wherein said step of utilising said data position information comprises:
applying a search algorithm to said data position information, wherein said search algorithm is configured to locate said target data; and
determining a required transporting of said logical data passed said read head to allow said target data to be read.

8. The method as claimed in claim 5, wherein said data position information in said centralised storage area relates to a plurality of selected data groups, said data groups being distributed across said length of tape.

9. The method as claimed in claim 5 further comprising the step of:
transferring said data position information within said centralised storage area to a reserve storage area.

10. A data position information storage and utilisation device comprising:
partitioned logical data distributed across a length of tape;
a reserved storage area to store data position information relating to said logical data;
a centralised storage area configured to store said information received from said reserve storage area, said centralised storage area being configured to store information relating to substantially all said partitioned logical data; and
a search algorithm to locate a target data on said tape; and
a read head configured to read said logical data on said tape;
wherein said device is operable, in response to a request for said target data, to locate said target data on said tape using said information in said centralised storage area and to read said target data using said read head.

11. A device as claimed in claim 10 wherein said reserve storage area is located on at least one portion of said tape.

12. A device as claimed in claim 10, wherein said reserve storage area is a cartridge memory.

13. A device as claimed in claim 10, wherein said centralised storage area is located substantially within a tape drive, said tape drive being configured with said read head.

14. A computer program comprising program commands for implementing a method of centralised data position information storage and utilisation, said method comprising the steps of:
arranging a byte stream of data into partitioned logical data;
storing data position information relating to said logical data in a reserve storage area;
transferring said information from said reserve storage area to a centralised storage area, wherein said centralised storage area is configured to store said information relating to substantially all said partitioned logical data; and
utilising said information in said centralised storage area to locate a target data being part of said logical data.

15. A computer program comprising program commands for implementing a method of storing and utilising data position information on a tape data storage device, said method comprising the steps of:
arranging a byte stream of data into partitioned logical data and recording said logical data onto a length of tape;
storing data position information relating to said logical data in a reserve storage area;
transferring said information from said reserve storage area to a centralised storage area located within said tape device, wherein said centralised storage area is configured to store said information relating to substantially all said partitioned logical data; and
utilising said information in said centralised storage area to locate a target data on said tape, said target data being part of said logical data; and
reading said target data using a read head.
